(19) United States
(12) Patent Application Publication
(10) Pub. No.: US 2014/0129260 A1
(43) Pub. Date: May 8, 2014

(54) METHOD AND DEVICE FOR PROVIDING APPLICATION SERVICE USING HEALTH CLASSIFICATION INFORMATION

(71) Applicant: Korea University Research and Business Foundation, Seoul (KR)

(72) Inventor: Yoon Kyoo Kang, Seoul (KR)

(73) Assignee: Korea University Research and Business Foundation, Seoul (KR)

(21) Appl. No.: 14/154,282

(22) Filed: Jan. 14, 2014

Related U.S. Application Data
(63) Continuation of application No. PCT/KR2012/005263, filed on Jul. 3, 2012.

(30) Foreign Application Priority Data
Jul. 14, 2011 (KR) 10-2011-0069743
Jul. 14, 2011 (KR) 10-2011-0069758

(51) Int. Cl. G06F 19/00

(52) U.S. Cl. CPC G06F 19/322
USPC 705/3

(57) ABSTRACT

The present application relates to a method for providing an application service using health category information, comprising the steps of: (a) receiving, from a user terminal, first data including at least one type of health category information from among information on bodily functions of a user, activity information, participation information, environmental factor information, and personal factor information; (b) extracting, from a database, a service provider for providing a service corresponding to the first data; (c) generating intervention information corresponding to the service and transmitting same to a service provider terminal of the service provider; and (d) receiving, from the service provider terminal, service data on the service provider corresponding to the intervention information.

### TECHNICAL FIELD

The present disclosure relates to a method and a device for providing an application service by using health classification information.

### BACKGROUND ART

Medical records regarding diseases, disorders, etc., have been prepared and classified by expert groups such as doctors in accordance with their specific purposes. People in other fields could not have easily accessed the medical records prepared and classified by the expert groups. Further, the medical records have been generated in a variety of ways depending on the expert groups dealing with the medical records.

In addition, it has been difficult to integrate and unify the medical records even in the same expert groups, due to the different types and characteristics of their laws and medical institutions. Accordingly, there have been appeared services such as electronic medical record (EMR), electronic health record (HER) and personal health record (PHR).

The EMR, the EHR and the PHR computerize medical records, such as information of progress, operation, discharge, nursing and examination results, and provides the medical records through a Web browser. Accordingly, the EMR, the EHR and the PHR may be regarded as relatively narrow services.

However, as the area of the medical services has recently extended to human being's overall life and health care, a need to provide a new concept of integrated medical services and application services is growing.

Especially, in addition to the medical approaches, there have been various approaches to services relevant to human being's healthy life. For example, there have been researches on personal optimal residential environments, researches on medical services, smart work services, smart university services, social network services, statistical estimation and hypothesis test services, and services for measuring quality of life. In this regard, a need to integrate and manage information relevant to human being's health in various fields is increasing.

In order to meet various demands for human being's healthy life, there has been suggested the necessity to more effectively provide services for classification of health related records and other relevant services for an individual and through an individual. For example, there is an application service, to which a social network service is applied.

The social network service generally indicates a web service providing interfaces and functions to enable various Internet users to form personal networks. The social network service provides functions to create personal links by using service members' various personal information and allow the members to share and expand the created personal relationships.

However, most of the social network services are different from one another only in terms of a method for forming networks and a method for providing services. There has been no service, which forms networks among users based on internationally standardized personal health classification information, i.e., the International Classification of Functioning, Disability and Health (ICF), and provides various information relevant to health through a network.

In this regard, Japanese Patent Application No. 2004-553199, which relates to an ICF information processing device, describes an ICF information use system for using ICF (International Classification of Functioning) information.

In addition, Korean Patent Application No. 10-2008-0133640, describes a method and a device for modeling a space by using a BIM (Building Information Modeling).

### DISCLOSURE OF THE INVENTION

### Problems to be Solved by the Invention

An illustrative embodiment of the present disclosure provides a method and a device for systemizing user's health classification information and providing a user's terminal with an application service relevant to health classification information by using the systemized health classification information. Specifically, an illustrative embodiment of the present disclosure provides a method and a device for providing an application service, which include an intervention server and a diagnosis information integration server to integrate and unify pieces of diagnosis information into health classification information, enabling users and various service providers to easily exchange information through a network.

In addition, another illustrative embodiment of the present disclosure provides a method and a device for providing an application service, where the application service is a social network service, and a user's health classification information corresponding to respective health classification components in a user's posting data is extracted, and multiple users are matched with and connected to one another based on the users' health classification information.

### Means for Solving the Problems

According to one aspect of the present disclosure, a method for providing an application service by using life situation, disability and health classification information through an application service provision device is provided. The method includes (a) receiving, from a user's terminal, first data containing the user's health classification information including at least one of body function information, activity information, participation information, environmental factor information and personal factor information; (b) extracting, from a database, a service provider to provide a service corresponding to the first data; (c) generating intervention information corresponding to the service and transmitting the intervention information to a service provider's terminal; and (d) receiving, from the service provider's terminal, the service provider's service data corresponding to the intervention information. The intervention information includes information of assignments assigned to the service provider.

According to another aspect of the present disclosure, a method for providing an application service by using health classification information. The method includes (a) receiving a user's posting data; (b) extracting, from the received posting data, the user's health classification information corresponding to each of health classification components; (c) matching two or more users with one another, based on the extracted user's health classification information; and (d) connecting the matched users to one another through a network. The health classification components are at least one domains of the user's health classification information including body function information, activity information, participation information, environmental factor information and personal factor information. The step (c) further comprises generating a community having the matched users as community members, and the step (d) generates a chatting channel among the matched users' terminals.

According to yet another aspect of the present disclosure, a device for providing an application service by using life situation, disability and heath classification information. The device includes a data reception unit that receives, from a user's terminal, first data containing the user's health classification information including at least one of body function information, activity information, participation information, environmental factor information and personal factor information; a service provider management unit that extracts, from a database, a service provider to provide a service corresponding to the first data; an intervention information management unit that generates intervention information corresponding to the service and transmits the intervention information to a service provider's terminal; and an application service management unit that receives, from the service provider's terminal, the service provider's service data corresponding to the intervention information. The intervention information includes information of assignments assigned to the service provider.

### Effect of the Invention

An aspect of the present disclosure provides a method for providing an application service by using health classification information, which can systemize a user's personal health classification information, and, using the systemized health classification information, can provide the user with an application service relevant to the health classification information's terminal.

According to an aspect of the present disclosure provides a device and a record medium for providing an application service by using health classification information, which include an intervention server and a diagnosis information integration server to integrate and unify pieces of existing diagnosis information into health classification information, by which users and various service providers can more easily be provided or provide information through a network.

According to still another aspect of the present disclosure provides an application service, which is a social network service, and by which a user's health classification information relevant to health classification components is extracted from the user's posting data, and multiple users are matched with and connected to one another based on the users' health classification information.

### BRIEF DESCRIPTION OF THE DRAWINGS

Non-limiting and non-exhaustive embodiments of the present disclosure will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a diagram for explaining a system for providing an application service by using health classification information in accordance with a first embodiment of the present disclosure;

FIG. 2 is a block diagram illustrating an intervention server, in the system for providing an application service in accordance with the first embodiment of the present disclosure;

FIG. 3 shows an example for assigned assignments to be transmitted by the intervention server to a service provider's terminal, in the system for providing an application service in accordance with the first embodiment of the present disclosure;

FIG. 4 is a flowchart for explaining a method for providing an application service by using health classification information in accordance with the first embodiment of the present disclosure;

FIG. 5 is a flowchart for explaining an EMR integration method, in the method for providing an application service in accordance with the first embodiment of the present disclosure;

FIG. 6 is a flowchart for explaining a process for extracting first data containing health classification information from a user's posting data, in the method for providing an application service in accordance with the first embodiment of the present disclosure;

FIG. 7 shows an example screen for extracting classification information from a user's posting data, in the method for providing an application service in accordance with the first embodiment of the present disclosure;

FIG. 8 is a flowchart for explaining a process for receiving a selected service provider from a user's terminal, in the method for providing an application service in accordance with the first embodiment of the present disclosure;

FIG. 9 is a diagram for explaining a system for providing an application service by using health classification information in accordance with a second embodiment of the present disclosure;

FIG. 10 is a block diagram illustrating a social networking service server, in the system for providing an application service in accordance with the second embodiment of the present disclosure;

FIG. 11 shows an example for extracting health classification components from a user's posting data and providing the information, in the system for providing an application service in accordance with the second embodiment of the present disclosure;

FIG. 12 shows an example for providing user's health classification components and user's health classification information, in the system for providing an application service by using health classification information in accordance with the second embodiment of the present disclosure; and

FIG. 13 is a flowchart for explaining a method for providing an application service by using health classification information in accordance with the second embodiment of the present disclosure.

### BEST MODE FOR CARRYING OUT THE INVENTION

Hereinafter, illustrative embodiments of the present disclosure will be described in detail with reference to the accompanying drawings so that inventive concept may be readily implemented by those skilled in the art. However, it is to be noted that the present disclosure is not limited to the illustrative embodiments but can be implemented in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element.

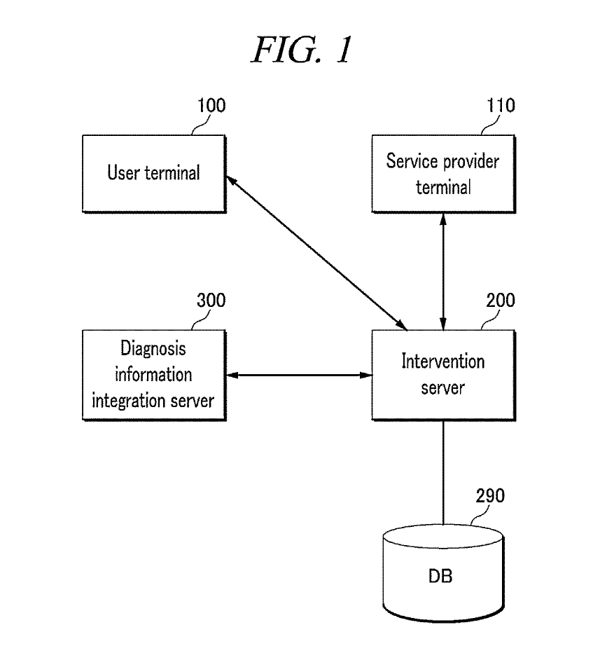

FIG. 1 is a diagram for explaining a system for providing an application service by using health classification information in accordance with a first embodiment of the present disclosure.

The system for providing an application service by using health classification information in accordance with the first embodiment of the present disclosure may include a user's terminal 100, a service provider's terminal 110, an intervention server 200, a database 290 and a diagnosis information integration server 300, which are connected via a network.

The user's terminal 100 and the service provider's terminal 110 may be implemented implemented in a form of a computer or a mobile device accessible to a remote server through a network. Here, the computer may include, for example, a notebook, a desktop, a laptop equipped with a Web browser and so on. The mobile device may be, for example, a wireless communication device assuring portability and mobility and include any types of handheld-based wireless communication devices such as a personal communication system (PCS), a global system for mobile communications (GSM), a personal digital cellular (PDC), a personal handyphone service (PHS), a personal digital assistant (PDA), an international mobile telecommunication (IMT)-2000, code division multiple access (CDMA)-2000, W-code division multiple access (W-CDMA), a wireless broadband Internet (Wibro)'s terminal and a smart phone.

The intervention server 200 receives first data containing health classification information from the user's terminal 100, selects a service provider to provide a service corresponding to the first data, provides intervention information to the service provider's terminal 110 of the selected service provider, and receives service data corresponding to the intervention information from the service provider's terminal 110 of the selected service provider. Here, the health classification information may include at least one of the user's body function information, activity information, participation information, environmental factor information and personal factor information.

The health classification information may be represented by the 1,424 codes that are classified according to the International Classification of Functioning, Disability and Health (ICF) of the World Health Organization (WHO). The first embodiment of the present disclosure includes modified information in this regard. The ICF enables human being's life associated with an environment to be classified into relevant components and severity of problems, intervention and outcomes of provision of intervention. The ICF is meaningful as it is designed to provide enriched information of human being's individual life by associating the existing International Classification of Diseases (ICD) and the International Classification of Health Intervention (ICHI) that is being developed by the World Health Organization (WHO).

The database 290 may be configured with a database management system (DBMS) to transmit and receive data, and is connected for communication to the intervention server 200.

The diagnosis information integration server 300 reads diagnosis information, which has already been processed into data with regard to a user, to transmit the diagnosis information to the intervention server 200, and receives converted data from the intervention server 200.

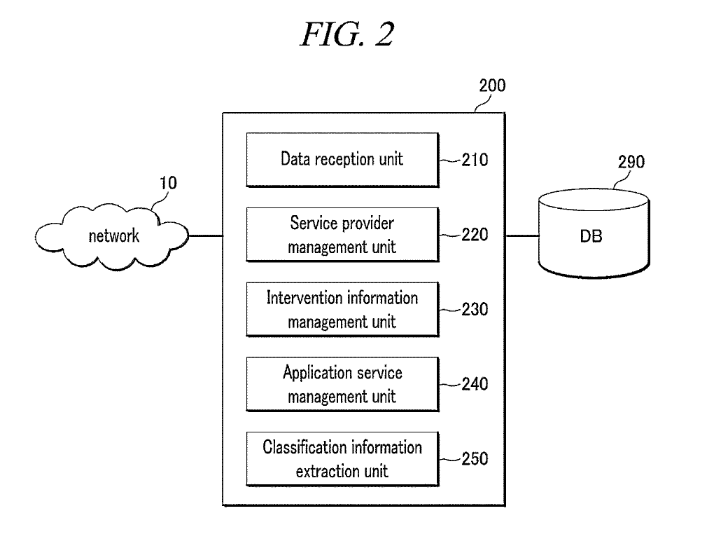

FIG. 2 is a block diagram illustrating the intervention server, in the system for providing an application service in accordance with the first embodiment of the present disclosure.

The intervention server 200 in accordance with the first embodiment of the present disclosure is connected through a network 10 and may include a data reception unit 210, a service provider management unit 220, an intervention information management unit 230, an application service management unit 240, and a classification information extraction unit 250.

The network 10 may be embodied in a form of wired networks such as a local area network (LAN), a wide area network (WAN) or a value added network (VAN), or any types of wireless networks such as a mobile radio communication network or a satellite communication network.

The data reception unit 210 receives, from the user's terminal 100, first data containing the user's health classification information including at least one of body function information, activity information, participation information, environmental factor information and personal factor information.

The first data may include health classification information corresponding to at least one qualifier of a problem, a facilitator and a barrier. For example, in case of back pain in the body function information, the qualifier of the problem may be rated from 4 to 0alleviation, 4 meaning the most severe pain. In case of an assistive product or service for the user's daily life in the environmental factor information, the qualifier of the facilitator may be represented on a scale of 0 to 4, 0 meaning the least helpful or the qualifier of a barrier may be rated from 4 to 0, 0 meaning the most helpful in alleviating the barrier.

The health classification information including body function information, activity information, participation information, environmental factor information, personal factor information and others is intended to provide systematic record means for a personal information system. Through the health classification information, it is possible to provide a scientific basis for understanding of broad, systematic and hierarchical health and health-related states, health-related outcomes, health-related determinants and so on. Further, health experts such as health care workers, researchers, policy makers, and the public including disabled persons can use the health classification information as a common language in order to facilitate their mutual communication.

The service provider management unit 220 may extract a service provider to provide a service corresponding to the first data from the database 290.

The service means a service corresponding to the first data containing the user's health classification information. Intervention such as a medical care service, a psychiatric clinic service and a residential environment improvement service may be provided depending on the user's health classification information and severity of problems. A service for providing a personally customized product, personally optimized architecture, and others may be provided depending on the qualifier of a problem, the qualifier of a facilitator and the qualifier of a barrier of the user. For example, an architectural service may include a service for architectural design, building, follow-up management and so on.

The service provider to provide the service may be automatically classified and extracted from the database 290 by the intervention server 200 based on the user's health classification information.

The intervention information management unit 230 may generate intervention information corresponding to the service and transmit the intervention information to the service provider's terminal 110 of the service provider.

The intervention information may include information of assignments assigned to the service provider and vary depending on the service to be provided to the user.

The intervention information may include architectural information to provide a building information modeling (BIM) service optimized for the user. BIM is a technique which can provide space construction information and in-space content information customized and specified for an individual user while reflecting expert intervention and determination for user's preference, goal and healthy life. For example, a user with impairment in the lower half of his/her body could not use normal stairs when going into and out of an apartment. Accordingly, it would be possible to provide the BIM service including ramp facilities for disabled persons, etc., by using the user's body function information received from the user's terminal. Further, it would be possible to provide the BIM service useful for exercise facility design, etc., by using activity information of apartment residents.

In addition, the intervention information may include personal service information for making goods or contents optimized for the user. The intervention information may be used for making goods optimized for the user by reflecting the user's body function information and personal factor information, and others. For example, the user's body function information and personal factor information, and information of assigned assignments (intervention) for making goods may be used in manufacturing a door grip, building a sink, and others for a user who is a left hander and uses a wheelchair.

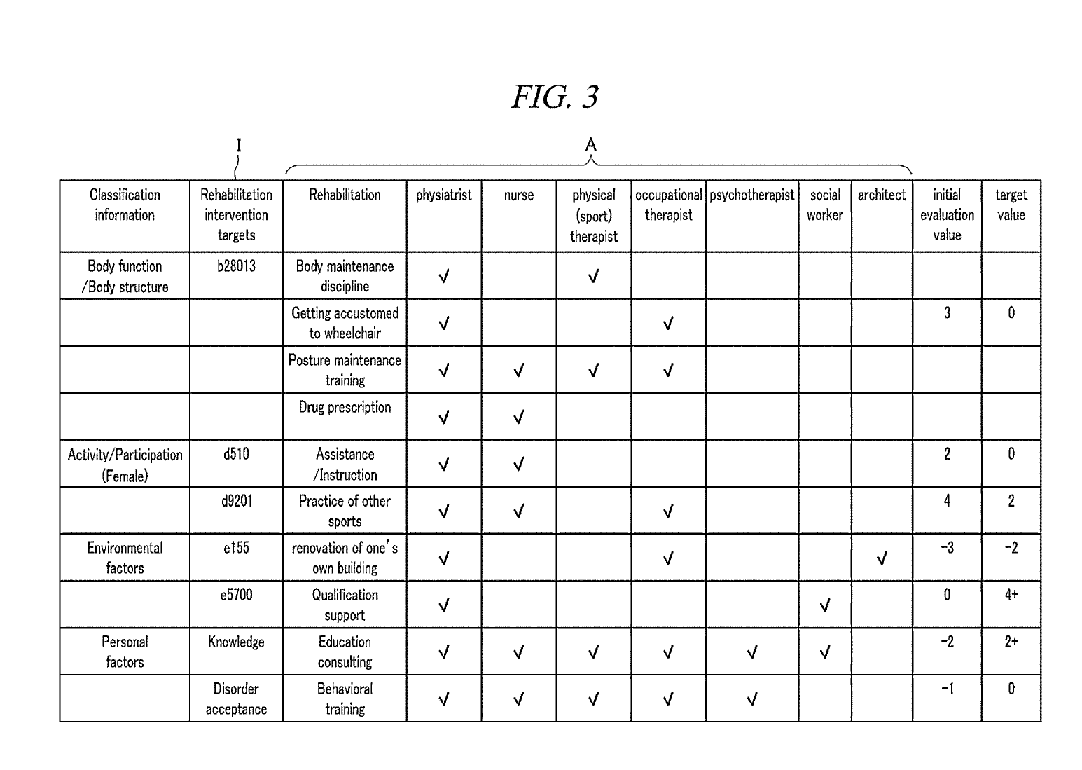

FIG. 3 shows an example for assigned assignments to be transmitted by the intervention server 200 to the service provider's terminal, in the system for providing an application service by using health classification information in accordance with the first embodiment of the present disclosure.

As shown in FIG. 3, the health classification information may describe pieces of information about life, impairments and health. Information codes (I) are included for the medical rehabilitation intervention targets (a goal of the intervention or a problem to be overcome by the intervention). Assigned assignments (A) are provided as specific components for the medical rehabilitation service to select a service (intervention) provider for each of the assignments. The initial evaluation value and the target value mean the first data and target data, respectively.

The application service management unit 240 may receive the service provider's service data corresponding to the intervention information from the service provider's terminal 110.

The service data correspond to the intervention information. For example, in the electronic medical record (EMR) convergence service, the user's evaluation information to integrate information about the user's screening examination results, operation progress, discharge summary and others into the health classification information may be provided as the service data. In addition, architectural information optimized for a user with impairment may be provided as the service data.

The classification information extraction unit 250 implements extracting health classification information such as the user's body function information, activity information, participation information, environmental factor information and personal factor information from a user's posting data received from the user's terminal 100.

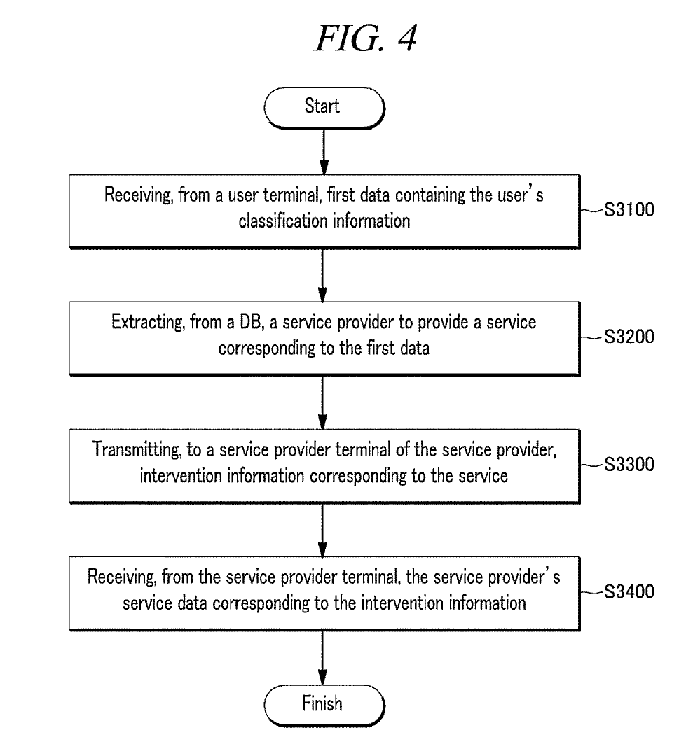

FIG. 4 is a flowchart for explaining a method for providing an application service by using health classification information in accordance with the first embodiment of the present disclosure.

The method for providing an application service in accordance with the first embodiment of the present disclosure may be implemented in a manner that an intervention server 200 is connected to a user's terminal 100 and a service provider's terminal 110 through a network 10.

First, the intervention server 200 receives, from the user's terminal 100, the first data containing the user's health classification information including at least one of body function information, activity information, participation information, environmental factor information and personal factor information (S3100).

Here, the body function information may include relative rating information regarding functioning of the user's each body part (e.g.: a mental function, a sensory function, a voice function, a cardiovascular function, a digestive function and a skin function). The activity information may include relative rating information regarding the user's learning ability (e.g., reading learning, writing learning, calculation learning, reading, writing and calculation),work performance capacity (e.g., ability to perform a work and ability to perform multiple works), and communication capacity, and mobility (e.g., body movement, carrying things around, and walking).

The participation information may include relative rating information regarding the user's interpersonal relationships, education and social participation. The environmental factor information may include relative rating information regarding the number and technologies of assistive goods for the user, and environmental features, (e.g., a natural environment state and an artificial environment state). The personal factor information may include relative rating information regarding the user's age, gender, ethnic group, nationality, motivation, self-esteem and social and economic standing, and others.

The body function information, the activity information, the participation information, the environmental factor information and the personal factor information may be coded with numerals or characters for their detailed classification, or coded and distinguished by including the qualifier of a problem, the qualifier of a facilitator and the qualifier of a barrier.

Next, the intervention server 200 extracts a service provider to provide the service corresponding to the first data from the database 290 (S3200).

Next, the intervention server 200 generates intervention information corresponding to the service and transmits the intervention information to the service provider's terminal (S3300).

Next, the intervention server 200 receives the service provider's service data corresponding to the intervention information from the service provider's terminal (S3400).

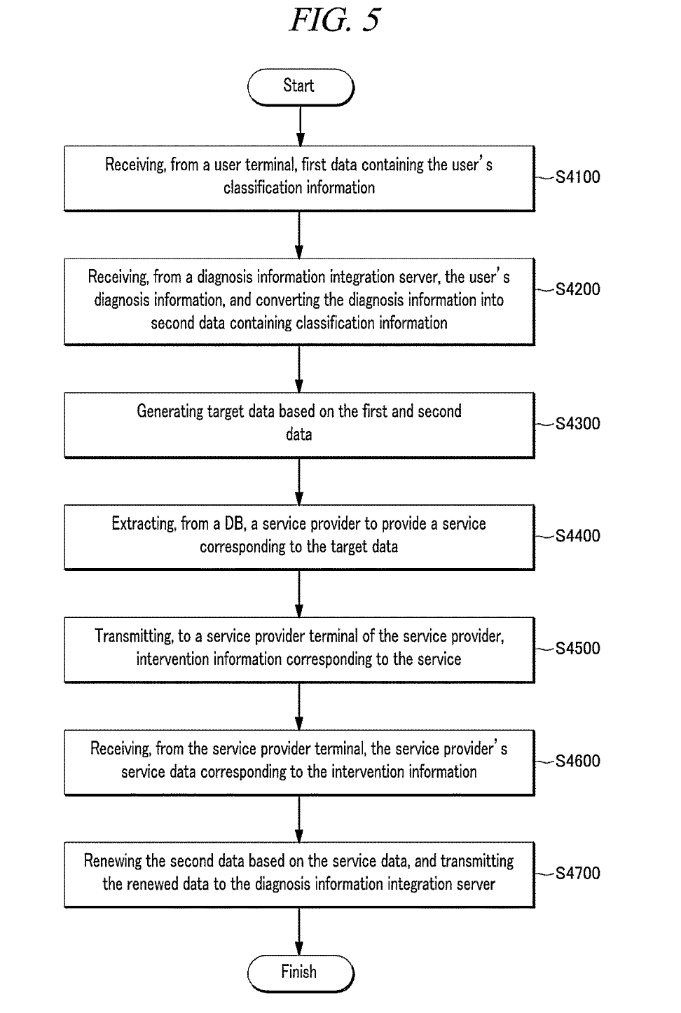

FIG. 5 is a flowchart for explaining an EMR convergence method, in the method for providing an application service in accordance with the first embodiment of the present disclosure.

First, the intervention server 200 receives the first data containing a user's health classification information from the user's terminal 100 (S4100).

Next, the intervention server 200 receives the user's diagnosis information from the diagnosis information integration server 300, and converts the diagnosis information into second data containing body function information, activity information, participation information, environmental factor information, personal factor information and so on (S4200).

The diagnosis information may be converted in correspondence to body function information. The diagnosis information means information diagnosed and processed into data according to a classification code system such as KCD codes under the Korean Standard Classification of Diseases (KCD), ICD codes under the International Classification of Diseases (ICD), MDC codes under the Main Diagnostic Categories (MDC), and others. Accordingly, in general, most diagnosis information corresponds to body function information. In addition, the conversion into the second data means receiving a variety of diagnosis information and a variety of life information, which are separated from one another, from the diagnosis information integration server 210 and converting the information into data containing body function information, activity information, participation information, environmental factor information, personal factor information and so on.

Next, the intervention server 200 generates target data based on the first data and the second data (S4300).

The intervention target data may be determined based on the first data received from the user's terminal 100 and the converted second data. The intervention target data, in correspondence with each of the user's body function information, activity information, participation information, environmental factor information, and personal factor information, can be calculated, for example, by using an average value of the first and second data or other statistical estimation and testing method.

Next, the intervention server 200 extracts a service provider to provide a service corresponding to the target data from the database (S4400).

The service provider may include experts in various fields of jobs such as a doctor, a nurse, a physical therapist, an occupational therapist, a psychotherapist, a social worker, an architect and an alternative medicine specialist. The service corresponding to the target data may include one or more of a problem alleviation service, a facilitation service and a barrier removal service, which corresponds to each of body function information, activity information, participation information, environmental factor information and personal factor information.

Next, the intervention server 200 transmits intervention information corresponding to the service to the service provider's terminal 110 of the service provider (S4500).

Next, the intervention server 200 receives the service provider's service data corresponding to the intervention information from the service provider's terminal 110 (S4600).

Next, the intervention server 200 updates the second data based on the service data, and transmits the updated data to the diagnosis information integration server 300 (S4700).

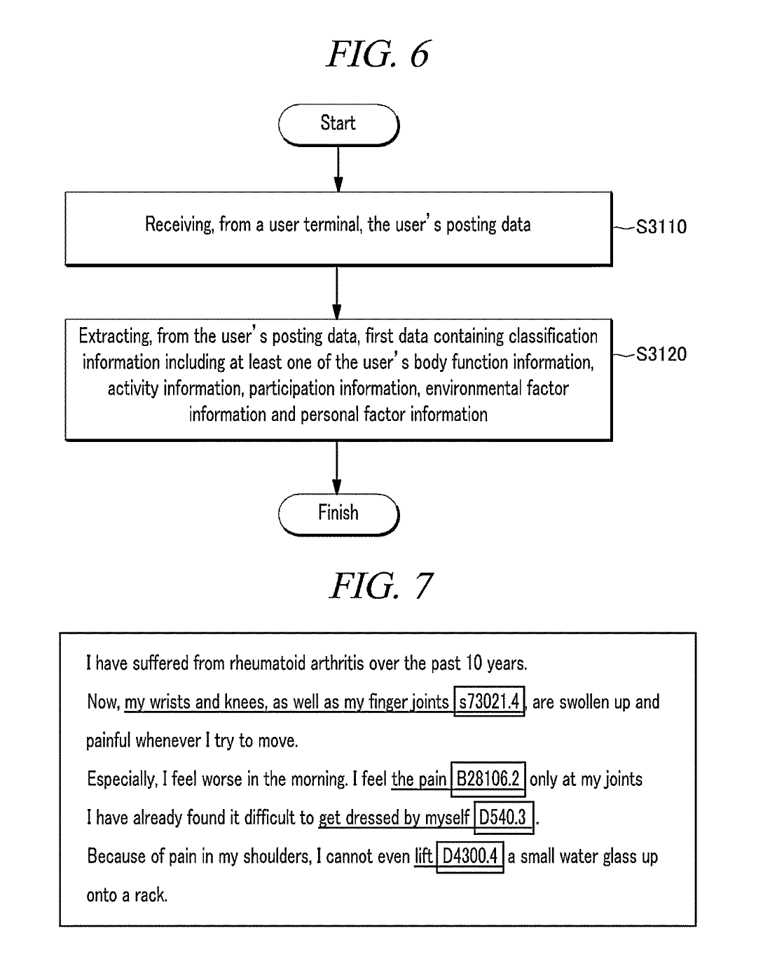

FIG. 6 is a flowchart for explaining a process for extracting the first data containing health classification information from a user's posting data, in the method for providing an application service in accordance with the first embodiment of the present disclosure.

The intervention server 200 may indirectly receive input of health classification information in a form of a posting data from the user's terminal 100. It would be difficult and cumbersome for a user to directly input his/her health classification information in a form of qualifiers. Further, it would be questionable in the aspect of reliability for a user to objectively rate and input his/her states. Thus, it is meaningful for a user to describe his/her states in a form of a diary or a blog, and extract the health classification information from the described content to utilize the information.

In this regard, the intervention server 200 may receive a user's posting data from the user's terminal 100 (S3110), and extract the first data containing the user's health classification information including at least one of body function information, activity information, participation information, environmental factor information and personal factor information from the user's posting data (S3120).

In order to extract the user's health classification information from the user's posting data, the intervention server 200 may implement parsing and filtering the posting data, semantic analysis regarding the meaning of the posting data, and others.

FIG. 7 shows an example screen for extracting health classification information from the user's posting data, in the method for providing an application service by using health classification information in accordance with the first embodiment of the present disclosure.

With reference to FIG. 7, there is suggested an example, in which a user suffering from rheumatoid arthritis writes and uploads his/her current state on his/her blog, and uses the writing in the blog to extract user's health classification information in accordance with the first embodiment of the present disclosure.

For example, in the health classification information, s73021 may refer to health classification information relevant to hands and finger joints, and D540 may refer to health classification information relevant to dressing up. Accordingly, the s73021 health classification information may be extracted from the writing “Now . . . my finger joints.” The health classification information relevant to dressing up may be extracted from the writing “getting dressed by myself.” In addition, it is possible to rate the qualifier of a problem regarding the extracted health classification information. From the user's expression “ . . . painful every time I try to move” regarding the finger joints related to s73021 in the blog, the qualifier of a problem in the finger joints may be rated “4” and expressed as “s73021.4” as shown in FIG. 7.

The extracted health classification information is provided to a service (intervention) provider who can provide the user (patient) with information about treatment, drug prescription, exercise prescription, and so on. The service provider may suggest a solution optimized for the user (patient) by using the health classification information.

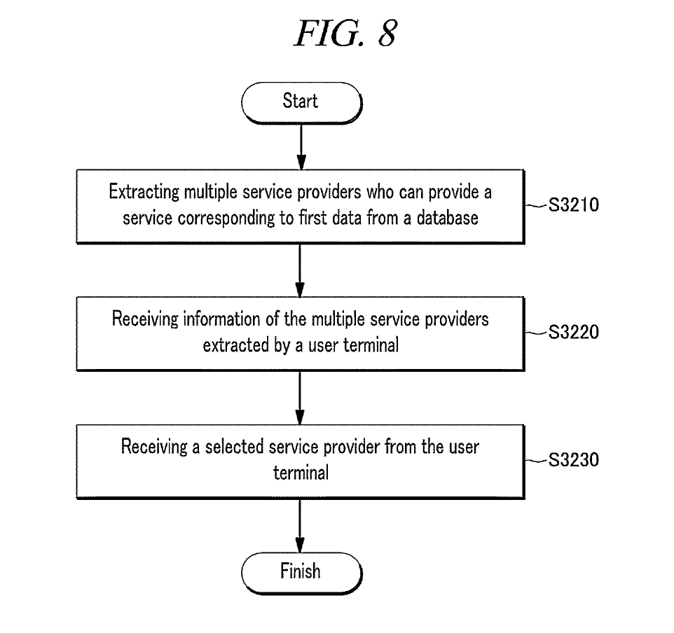

FIG. 8 is a flowchart for explaining a process for receiving a selected service provider from the user's terminal 100, in the method for providing an application service in accordance with the first embodiment of the present disclosure.

First, the intervention server 200 extracts multiple service providers who can provide the service corresponding to the first data from the database 290 (S3210).

The database 290 stores multiple service providers who can provide a user with a service regarding body function information, activity information, participation information, environmental factor information and personal factor information. Here, the multiple service providers may provide the same or different services. For example, for arthritis, there may be service providers such as medicine specialists who provide drug remedy information and physical therapists who provide exercise prescription. In addition, the service providers may include architects who provide patient-customized residential space design information, in order to provide a residential space optimized for the arthritis patient.

Next, the intervention server 200 transmits the information of the extracted multiple service providers to the user's terminal 100 (S3220).

Next, the intervention server 200 receives a selected service provider from the user's terminal 100 (S3230).

Now, a device for providing an application service for provision of a social network service using health classification information is described.

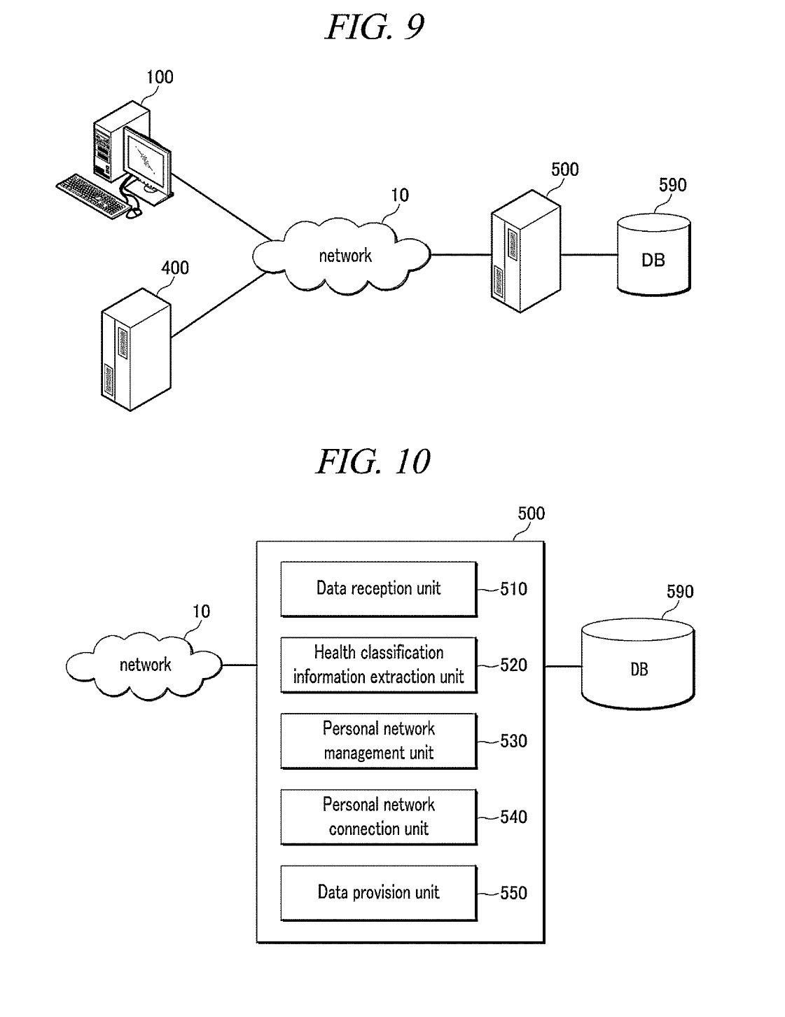

FIG. 9 is a diagram for explaining a device for providing an application service by using health classification information in accordance with a second embodiment of the present disclosure.

The system for providing an application service in accordance with the second embodiment of the present disclosure provides a social network service using health classification information.

Specifically, the system for providing an application service in accordance with the second embodiment of the present disclosure may include the user's terminal 100, a posting data storage server 400, a social networking service server 500 and a database 590, which are connected to the network 10.

The user's terminal 100 may be implemented in a form of a computer or a mobile device accessible to a remote server. Here, the computer may include, for example, a notebook equipped with Web browser, a desktop, a laptop and so on. The mobile device may be, for example, a wireless communication device assuring portability and mobility, and include any types of handheld-based wireless communication devices such as a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), a wireless broadband Internet (Wibro) terminal and a smart phone.

The posting data storage server provides a web service containing a user's posting data and stores the posting data. For example, the posting data storage server may be a web server which provides a blog service, a community service and others in a portal site.

The social networking service server 500 extracts a user's health classification information corresponding to health classification components contained in the user's posting data. Based on the extracted information, the social networking service server matches similar users with one another to connect them to one another.

As described in the first embodiment of the present disclosure above, the health classification components mean domains or an aggregation of domains, which have at least one of the user's body function information, activity information, participation information, environmental factor information and personal factor information. For example, the health classification components may be represented with the 1,424 codes that are classified according to the International Classification of Functioning, Disability and Health (ICF) of the World Health Organization (WHO). The second embodiment of the present disclosure includes modified information in this regard. The ICF enables depiction of human being's functions and their associated barrier factors. The ICF is a result of efforts to integrate individual and social models of disability, and designed to be complementarily used together with the International Classification of Diseases. While the International Classification of Diseases focuses on diagnosis of diseases, the ICF is designed to provide much information about life (functioning). The ICF classification is merely an example of health classification components and the health classification components may use another classification system.

The user's health classification information means the user's information corresponding to health classification components. For example, in case of a health classification component of a “legal service” in “environmental factor information,” a user may rate his/her legal service environmental factor on a scale of “no barrier (0)” to “complete barrier (4).” Here, the health classification component and the rating information for the health classification component form the user's health classification information.

The database 590 may be configured by a database management system (DBMS) for transmitting and receiving data and is connected for communication to the social networking service server 500. Here, the database 590 in accordance with the second embodiment of the present disclosure may be the same as the database 290 of FIGS. 1 and 2.

FIG. 10 is a block diagram illustrating a social networking service server, in the system for providing an application service by using health classification information in accordance with the second embodiment of the present disclosure.

The social networking service server 500 in accordance with the second embodiment of the present disclosure may include a data reception unit 510, a health classification information extraction unit 520, a personal network management unit 530, a personal network connection unit 540, a data provision unit 550 and a database 590.

The data reception unit 510 receives a user's posting data from the user's terminal 100 or the posting data storage server 400 that stores the user's posting data.

The social networking service server 500 may provide the user with an interface for posting and receive the posting data from the user's terminal 100. The social networking service server 500 may receive and utilize posting data on a blog, an online community etc., which the user has posted regarding his/her daily life without restriction of formality. Conventionally, health classification used to focus on the user's medical health state. In recent, however, the ICF codes, etc., have begun to adopt interests in functional parts, activity parts, participation parts, and so on in human being's daily life. Accordingly, the user's posting data stored in the posting data storage server 400 are significantly useful in extracting the user's health classification information. Since already written data can be used, it is possible to provide the user with convenience.

The health classification information extraction unit 520 may extract the user's health classification information corresponding to each of health classification components contained in the user's posting data.

More detailed description in this regard is provided with reference to FIG. 7.

The posting data contain information associated with some health classification components, such as finger joints s73021, pain B28106, getting dressed D540, put up D4300, a occupational therapist e355, a bottle opener e115, a student e340 and husband e310, regarding the user “xyz.” The health classification information extraction unit 520 may extract the health classification components (s73021, B28106, D540, D4300, e355, e115, e340 and e310 in the example of FIG. 3), and the words associated with the health classification components, based on the words, the context information, etc., included in the user's posting data.

More specifically, the health classification information extraction unit 520 may analyze meaning of each of the words contained in the posting data, contextual meaning thereof in the posting data, and others through a semantic analysis of the user's posting data. To this end, the health classification information extraction unit 520 may divide the posting data into token units, and extract morphemes from each of the tokens to utilize the morpheme. The extracted morphemes may be extended and utilized with reference to thesaurus and others.

The user's health classification information extracted by the health classification information extraction unit 520 may be recorded in the database 590 in association with the user's identification information (e.g., ID). The user's health classification information recorded in the database 590 may be used when users are matched with one another, and when a request for reading a variety of information is made by using the user's identification information.

The personal network management unit 530 may match two or more users with one another, based on the user's health classification information extracted from the user's posting data.

Basically, the user matching may be implemented based on a degree of similarity in the health classification information and the health classification components contained in the health classification information. Also, the user matching may be implemented based on the user's each posting data or the user's all posts. For example, if the user matching is implemented based on one posting data regarding rheumatoid arthritis written by a rheumatoid arthritis patient, users suffering from rheumatoid arthritis may be matched with one another. On the other hand, if the user matching is implemented based on all posts written by a rheumatoid arthritis patient, users using wheelchairs may be matched with one another focusing on persons' activity information, rather than the disease (rheumatoid arthritis) itself. For example, among the users using wheelchairs, people residing in an apartment and experiencing inconvenience from stairs at the entrance of the apartment may be matched with one another.

In addition, the personal network management unit 530 may match two or more users with one another, based on personal information including at least one of the user's location information, age information, gender information, attended school information and treatment history information, other than the user's health classification information.

The users matched by the personal network management unit 530 may be provided with information of their counterpart users. The user information may be provided through an e-mail or a message in a social network service, a text message using a mobile communication terminal, or others. The user information may be provided in various ways other than those described above.

The personal network connection unit 540 may connect the users matched by the personal network management unit 530 to one another through the network 10.

The personal network connection unit 540 may generate and provide a community having the matched users as community members, and generate and provide a chatting channel among the matched users.

For example, the social networking service server 500 may generate a community by matching users who have received exercise prescription with respect to pain in waist. In addition, the social networking service server 500 may provide the matched users with a messenger service and others to enable the users to communicate with one another in real time through the Internet.

The data provision unit 550 receives a request for reading the user's health classification information associated with the health classification components from the user's terminal 100, extracts the user's health classification information stored in association with the user's identification information in the database 590, and provides the extracted information to the user's terminal 100.

The data provision unit 550 may provide the user's terminal 100 with at least one of health classification components for the words set as the user's health classification information and image objects associated with the words in the user's posting data.

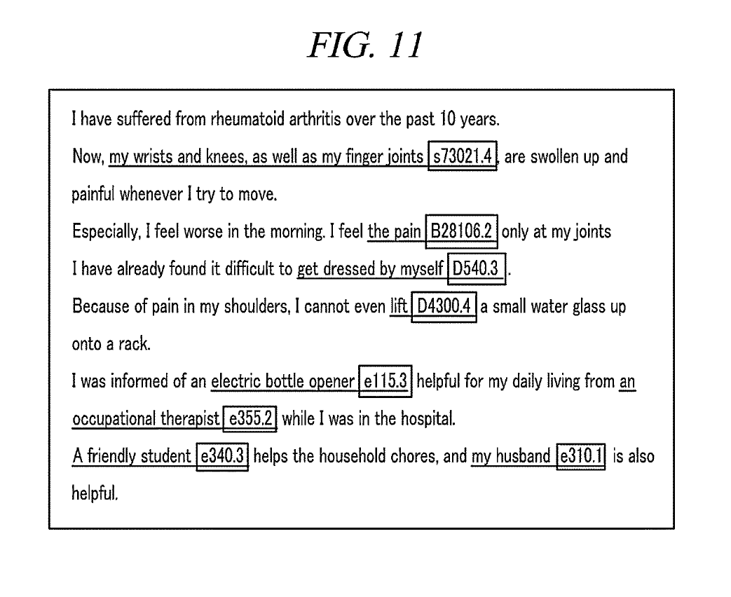

FIG. 11 shows an example for extracting and providing health classification components from user's posting data, in the system for providing an application service in accordance with the second embodiment of the present disclosure.

As shown in FIG. 11, the social networking service server 500 may provide health classification components, such as finger joints s73021, pain B28106, getting dressed D540, lift up D4300, an occupational therapist e355, a bottle opener e115, student e340 and husband e310 close to the respective words in the user's posting data.

For example, s73021 may refer to classification information relating to a hand and finger joints, and D540 may refer to classification information relating to dressing up. Accordingly, the s73021 health classification information may be extracted from the writing “Now . . . my finger joints.” The health classification information relating to dressing up may be extracted from the writing “get dressed by myself.” In addition, it is possible to determine the qualifier of a problem regarding the extracted health classification information. From the user's expression “ . . . painful every time I try to move” regarding the finger joints related to s73021 in the blog, the qualifier of the problem in the finger joints may be rated “4” and expressed by “s73021.4” as shown in FIG. 7.

The extracted health classification information is provided to a service (intervention) provider who can provide a user (patient) with information about treatment, drug prescription, exercise prescription and others. The service provider may propose a solution optimized for the user (patient) by using the health classification information.

The social networking service server 500 may receive a request for information about the health classification components from the user's terminal 100 and extract intervention information stored in association with the health classification components from the database 590 to provide the information to the user's terminal 100.

Here, the intervention information may include at least one of treatment information associated with the health classification components, treatment center information, web page links and information of a service provider providing a service, e.g., a residential environment improvement service, associated with the health classification components.

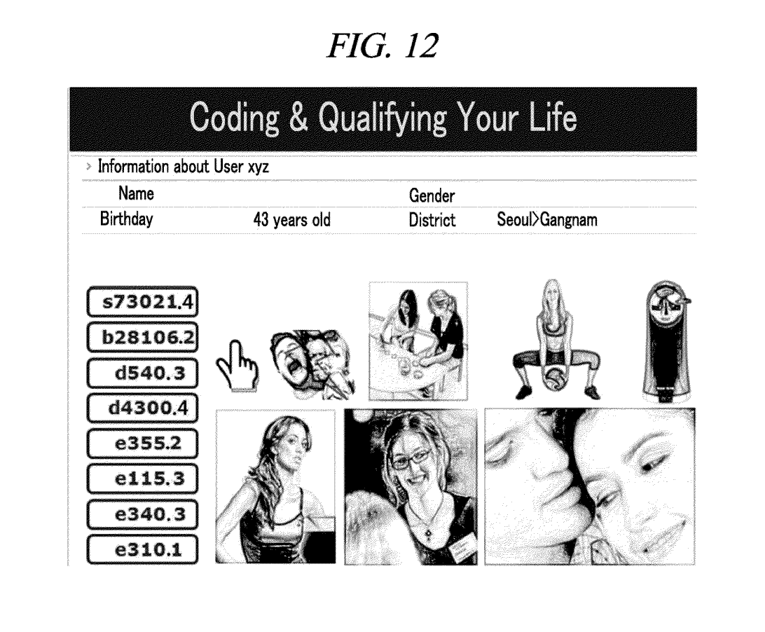

FIG. 12 shows an example for providing user's health classification components and user's health classification information, in the system for providing an application service by using health classification information in accordance with the second embodiment of the present disclosure.

With reference to FIG. 12, the social networking service server 500 provides basic personal data (name, gender, birthday, residence and so on) of the user xyz, health classification components of the user xyz, and multimedia data (image data in the example of FIG. 12) associated with the health classification components, in response to a request for reading health classification information from the user xyz.

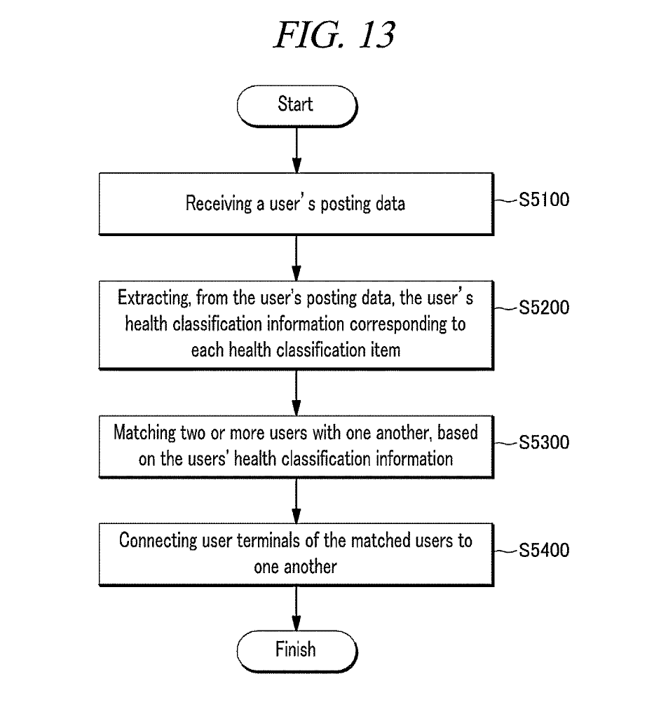

FIG. 13 is a flowchart for explaining a method for providing an application service by using health classification information in accordance with the second embodiment of the present disclosure.

The method for providing an application service in accordance with the second embodiment of the present disclosure may be implemented in a manner that the social networking service server 500, the user's terminal 100 and the posting data storage server 400 are connected to one another through a network 10.

First, the social networking service server 500 receives a user's posting data (S5100).

As described above, the user's posting data may be posting data written and uploaded by the user through the interface provided by the social network system, or the user's posting data already recorded in the posting data storage server 400.

Next, the social networking service server 500 extracts the user's health classification information corresponding to each of health classification components in the user's posting data (S5200).

Next, the social networking service server 500 matches two or more users with one another based on the users' health classification information (S5300).

Next, the social networking service server 500 connects the matched users to one another through the network (S5400).

The social networking service server 500 may provide the user's terminal 100 with at least one of health classification components for the words contained in the user's posting data and image objects associated with the words, after S5100 or S5400.

For reference, each of the components illustrated in FIGS. 2 and 10 in accordance with the first and second embodiments of the present disclosure may imply software or hardware such as a field programmable gate array (FPGA) or an application specific integrated circuit (ASIC), and carry out its predetermined function.

However, the “components” are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided.

The illustrative embodiments of the present disclosure can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the illustrative embodiments of the present disclosure is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

The scope of the inventive concept of the present disclosure is defined by the following claims and their equivalents rather than by the detailed description of the illustrative embodiments. It shall be understood that all modifications and embodiments conceived from the meaning and scope of the claims and their equivalents are included in the scope of the inventive concept.

What is claimed is:

1. A method for providing an application service by using life situation, disability and health classification information through an application service provision device, the method comprising:
(a) receiving, from a user's terminal, first data containing the user's health classification information including at least one of body function information, activity information, participation information, environmental factor information and personal factor information;
(b) extracting, from a database, a service provider to provide a service corresponding to the first data;
(c) generating intervention information corresponding to the service and transmitting the intervention information to a service provider's terminal; and
(d) receiving, from the service provider's terminal, the service provider's service data corresponding to the intervention information,
wherein the intervention information includes information of assignments assigned to the service provider.

2. The method of claim 1,
wherein the step (a) comprises:
(a-1) receiving, from the user's terminal, the user's posting data; and
(a-2) extracting the first data from the received posting data.

3. The method of claim 1,
wherein the step (b) comprises:
(b-1) receiving, from a diagnosis information integration server, the user's diagnosis information, and converting the diagnosis information into second data containing the user's health classification information including at least one of body function information, activity information, participation information, environmental factor information and personal factor information;
(b-2) generating the user's target data based on the first data and the second data; and
(b-3) extracting, from the database, a service provider to provide a service corresponding to the target data, and the method further comprises:
(e) updating the second data based on the service data; and
(f) transmitting the updated data to the diagnosis information integration server.

4. The method of claim 3,
wherein the service corresponding to the target data includes one or more of a problem alleviation service, a facilitation service and a barrier removal service, which correspond to one or more of the body function information, the activity information, the participation information, the environmental factor information and the personal factor information.

5. The method of claim 1,
wherein the step (b) comprises:
(b-1) extracting, from the database, a plurality of service providers capable of providing the service corresponding to the first data;
(b-2) transmitting, to the user's terminal, information of the extracted plurality of service providers; and
(b-3) receiving, from the user's terminal, a selected service provider.

6. The method of claim 1,
wherein in the step (b), the service corresponding to the first data includes an architectural service, and
in the step (c), the intervention information includes the first data of the user and architectural information for providing a BIM (Building Information Modeling) service optimized for the user.

7. The method of claim 1,
wherein in the step (b), the service corresponding to the first data includes a service for making a customized good,
in the step (c), the intervention information includes the first data of the user and personalization information for making a good optimized for the user.

8. The method of claim 1,
wherein the body function information includes relative rating information regarding functioning of the user's each body part,
the activity information includes relative rating information regarding learning ability, work performance capacity, communication capacity and mobility of the user,
the participation information includes relative rating information regarding interpersonal interactions and relationships of the user,
the environmental factor information includes relative rating information regarding the number and technologies of assistive goods for the user, and environmental features of the user,
the personal factor information includes relative rating information regarding age, gender, ethnic group, nationality, motivation, self-esteem and social and economic standing of the user.

9. The method of claim 1,
wherein the first data is health classification information corresponding to at least one of a problem qualifier, a facilitator qualifier and a barrier qualifier.

10. A device for providing an application service by using life situation, disability and heath classification information, the device comprising:
a data reception unit that receives, from a user's terminal, first data containing the user's health classification information including at least one of body function information, activity information, participation information, environmental factor information and personal factor information;
a service provider management unit that extracts, from a database, a service provider to provide a service corresponding to the first data;
an intervention information management unit that generates intervention information corresponding to the service and transmits the intervention information to a service provider's terminal; and
an application service management unit that receives, from the service provider's terminal, the service provider's service data corresponding to the intervention information;
wherein the intervention information includes information of assignments assigned to the service provider.

11. The device of claim 10,
wherein the data reception unit further receives, from the user's terminal, the user's posting data, and
further comprises a classification information extraction unit that extracts, from the user's posting data, the first data containing the user's health classification information including at least one of body function information, participation information, environmental factor information and personal factor information.

12. The device of claim 10,
wherein the service provider management unit extracts, from the database, a plurality of service providers capable of providing a service corresponding to the health classification information, transmits, to the user's terminal, information of the extracted plurality of service providers, and receives, from the user's terminal, a selected service provider.

13. The device of claim 10,
wherein the service corresponding to the first data is an architectural service, and
the intervention information includes the first data of the user and architectural information for providing a BIM (Building Information Modeling) service optimized for the user.

14. The device of claim 10,
wherein the service corresponding to the first data is a service for making a customized good, and
the intervention information is the first data of the user and the personalization information for making a good optimized for the user.

15. A method for providing an application service by using health classification information, the method comprising:
(a) receiving a user's posting data;
(b) extracting, from the received posting data, the user's health classification information corresponding to each of health classification components;
(c) matching two or more users with one another, based on the extracted user's health classification information; and
(d) connecting the matched users to one another through a network,
wherein the health classification components are at least one domains of the user's health classification information including body function information, activity information, participation information, environmental factor information and personal factor information,
the step (c) further comprises generating a community having the matched users as community members, and
the step (d) generates a chatting channel among the matched users' terminals.

16. The method of claim 15,
wherein the step (b) comprises:
(b-1) performing a word analysis of the received posting data to extract a word list; and
(b-2) extracting, from the word list, words matched with the health classification components to generate the user's health classification information using the extracted words.

17. The method of claim 16, the method further comprising:
(e) providing, to the user's terminal, the user's health classification information generated using the extracted words and image objects associated with the extracted words,
(f) receiving, from the user's terminal, a request for more information of the provided health classification components;
(g) extracting, from the database, intervention information associated with the health classification components; and
(h) providing the intervention information to the user's terminal.

18. The method of claim 17,
wherein the intervention information includes at least one of treatment information, treatment center information, web page links, and information of a service provider providing a service associated with the health classification components.

19. The method of claim 15, the method further comprising:
(i) storing, into the database, the user's health classification information extracted in the step (b) with the user's identification information.

20. The method of claim 19, the method further comprising:
(j) receiving, from the user's terminal, a request for the user's health classification information associated with the health classification components ;
(k) extracting, from the database, the user's health classification information using the user's identification information; and
(l) providing, to the user's terminal, the extracted user's health classification information.
